(19) United States
(12) Patent Application Publication
(10) Pub. No.: US 2004/0204950 A1
(43) Pub. Date: Oct. 14, 2004

(54) System and method for online meal customization and reporting

(76) Inventor: Stephanie Vlahos, San Mateo, CA (US)

Correspondence Address: Douglas A. Chaikin, Peninsula IP Group, Suite 101, 2290 North First Street, San Jose, CA, 95131, US

(21) Appl. No.: 10/412,018

(22) Filed: Apr. 11, 2003

(51) Int. Cl. G06F 17/60

(52) U.S. Cl. 705/1

(57) ABSTRACT

Disclosed herein is an online meal customization and reporting method, comprising receiving meal selection data from at least one participant; maintaining the at least one meal selection data in an accessible format; and providing the at least one meal selection data to an authorized party. A customized lunch ordering and reporting system, comprising at least one processor; and memory, coupled to the at least one processor, the memory including instructions that when executed on the at least one processor, causes the at least one processor to: receive a lunch selection from at least one participant; maintain the at least one lunch selection in an accessible format; and provide the at least one lunch selection to an authorized party.

### FIELD OF THE INVENTION

This invention generally relates to automated menu customization and, more particularly, to a system and method for allowing individual users to select food and/or beverage items online and the customized reporting of such selections.

### BACKGROUND OF THE INVENTION

Elementary schools, junior high schools, senior high schools, corporations and other suitable institutions often implement lunch or other meal programs to provide hot and/or cold entrees and accompanying beverages and side dishes to enrolled students and/or other suitable participants. When implemented in schools, for example, volunteers or a paid staff member (e.g. meal coordinator) often run the meal program. The meal coordinator or suitable volunteer is responsible for gathering the individual meal selections from the many students or other participants. Gathering meal selections involves tabulating the myriad combination of entrees and corresponding beverage and side dish combinations, for example, desserts, potato chips, salads and other suitable dishes from each student or participant and ordering such combination of meals from a variety of vendors, for example, restaurants, delis and other suitable food providing entities that service the program.

A drawback with conventional lunch or meal programs, for example, is the time and expense of labor used to implement and maintain such programs. In a volunteer-run school program, for example, the meal coordinator is responsible for going to each classroom and gathering the lunch orders, for example, from every student. In those situations where the teacher gathers the meal selections from each of the student participants, the meal coordinator must traverse each classroom and collect the meal selections from the several rooms of the school. When the school or other suitable institution is very large, the collection process is time consuming. To relieve a single person from performing the gathering process daily, multiple volunteers may be used. However, this may result in the duplication of efforts, if two or more of the volunteers inadvertently gather menu selections from the same classroom or floor or series of classrooms or floors. When this occurs, one or more classrooms or floors may be overlooked. Thereby resulting in one or more students not getting their selected meal.

Another drawback with lunch programs and the administration thereof is the selection process that often accompanies such programs. Typically, the student manually selects one of several offerings on any given day. As may sometime arise, the student may inadvertently mark an area not corresponding to any entrée or accompanying side dish, or in the situation where the menu encompasses multiple time periods, select an incorrect menu selection. When this occurs, the meal coordinator or volunteer must locate the student and have the student make another selection. In a school with a large student population, multiple incorrect selections will have an adverse impact on the administration of the lunch program, both from a tabulation standpoint and a food delivery standpoint, as all incorrect menu orders must be corrected before the aggregate order can be made or delivered by the one or more vendors that service the program.

### SUMMARY OF THE INVENTION

An object of the present invention is to provide online customized meal selection for participants in lunch or other suitable meal program.

Another object of the present invention is to provide automated reporting of the aggregate menu selections for the lunch or other suitable meal program.

In accordance with the present invention, an online meal customization and reporting method includes receiving meal selection data from at least one participant. In an exemplary embodiment, the participant, for example, a student or parent, selects at least one lunch entrée and beverage from a list of available options. The at least one lunch entrée and beverage selection is maintained in an accessible format in a database for subsequent manipulation and reporting purposes. The at least one meal selection data is then provided to an authorized party. In an exemplary embodiment, a listing of the at least one lunch entrée and beverage selections is provided, for example, to the meal plan administrator upon request from the meal plan administrator. In an alternate embodiment, a table representing the aggregate lunch count per specific parameter, such as period of time or classroom may be provided to the meal plan administrator.

In accordance with the present invention, a customized lunch ordering and reporting system includes at least one processor, for example, a server containing a database of authorized participants and corresponding meal plan providing institutions. Also included is a memory, coupled to the at least one processor. The memory contains instructions that when executed on the at least one processor, causes the at least one processor to receive a lunch selection from at least one participant. In an exemplary embodiment, the participant, for example, a student or the parent of the student, makes a lunch entrée and beverage selection from a list of options. The instructions then cause the at least one processor to maintain the entréee and beverage selections in an accessible format. The maintained entrée and beverage selections are then provided to an authorized party, for example the meal plan administrator, upon receipt of a request from the meal plan administrator.

The meal plan administrator is provided with either an aggregate number of entrees and beverages ordered or a more detailed listing relating a participant and the particular entrée/beverage combination ordered. With this information, the meal plan administrator may order the appropriate number of entrees and/or beverages from the vendors, for example, restaurants, delis or other suitable food providing entity that service the lunch program.

An advantage of the present invention is that it reduces the amount of time to administer a lunch or other suitable meal program.

Another advantage of the present invention is that it reduces the amount of labor required to administer a lunch or other suitable meal program.

Yet another advantage of the present invention is that it reduces the costs associated with administering a lunch or other suitable meal program.

### BRIEF DESCRIPTION OF THE DRAWINGS

For a further understanding of the objects and advantages of the present invention, reference should be made to the following detailed description of the invention, taken in conjunction with the accompanying drawings, in which like parts are given like reference numerals and wherein:

FIG. 1 is a diagram illustrating a system configured to provide the online meal program according to an exemplary embodiment of the present invention;

FIGS. 2-4 represent a flowchart illustrating the operating steps performed by the system illustrated in FIG. 1 when performing the online meal program according to an exemplary embodiment of the present invention;

FIG. 5 is a graphic representation of the login screen used by the online meal program participant to access the meal selection portion of the system according to an exemplary embodiment of the present invention;

FIG. 6 represents an exemplary menu provided by the online meal program system of the present invention;

FIG. 7 represents the data maintained by the online meal program database after being entered by the program participant;

FIG. 8 is a graphic representation of the menu selections maintained by the online meal program database in tabular form according to an exemplary embodiment of the present invention;

FIG. 9 represents an exemplary table providing the total number of meals ordered through the online meal program for a specified time period according to the present invention; and

FIG. 10 represents an exemplary table providing the total number of meals ordered through the online meal program according to an alternate embodiment of the present invention.

### DETAILED DESCRIPTION OF THE INVENTION

An exemplary embodiment of the present invention will now be described with reference to FIGS. 1-10. Although the exemplary embodiment describes a lunch program, it will be appreciated by one of ordinary skill in the art that the corresponding disclosure and invention is equally applicable to a breakfast, dinner or other suitable meal program and such disclosure is contemplated to cover such alternate uses. Specific hardware and/or software capable of performing the operations associated with the present invention will not be described in great detail so as not to obscure the disclosure and teachings of the present invention. It will be appreciated by those of ordinary skill in the art that various programming and coding schemes may be used to implement the functionality of the present invention and such schemes and precise coding are contemplated by the present invention and fall within the spirit and scope of the present disclosure.

FIG. 1 is a diagram illustrating a system 10 configured to provide the online meal program of the present invention. The system 10 includes a server 12, for example at least one processor or other suitable device capable of executing a program or series of instructions that are maintained in a suitable volatile or non-volatile memory 14, a plurality of clients 20-24, for example, personal computers, internet appliances or other suitable devices capable of accessing a communication network 40, for example, the Internet and an institutional participant 26, for example, the meal plan administrator at a participating school. As the several clients 20-24 are substantially similar, only the components and functionality of client 20 will be described in greater detail so as not to obscure the teachings of the present disclosure.

The server 12 includes the memory 14 for maintaining the database, for example, an Access 2000 database and corresponding pages and the program instructions that are operable to generate such database and pages, a network controller 16 operable to connect one or more of the clients 20-24 to the server 12 and to transfer applicable data 15, for example, lunch menu selections and applicable participant selection and reporting pages between the server 12 and the one or more clients 20-24, and a payment server 18 operable to send/receive payment data 38, 48 corresponding to the meal (e.g. lunch) program between the server 12 and the corresponding financial institution, for example, bank, credit union or other suitable institution (not shown) of the user or meal plan participant.

The client 20 may be represented as a personal computer, Internet appliance or other suitable device capable of connecting to the communication network 40 and transmitting information therebetween. Although represented as the Internet, the communication network 40 may be implemented, for example, as a local area network (LAN), a wide area network (WAN), a token ring or other suitable communication network. The client 20 includes a browser (e.g. Internet Explorer) or other suitable network connection mechanism 30, an input/output (I/O) device 32, for example, a keyboard, touch pad, mouse, joystick or other suitable data input device, a display 34, for example, a CRT, flat panel or other suitable visual presentation device and a peripheral device 36, for example a printer. A user, for example, a student or parent may access the online meal program database of the present invention by activating the browser 30 and entering the address or URL (e.g. orderlunches.com) of the server 12 on the I/O device 32. Upon entering the address, the browser 30 will connect the client 20 to the communication network 40 via network link 31. Once connected to the communication network 40, the client 20 may access the server 12.

The institutional participant 26, for example, the meal plan administrator at an authorized school, corporation or other suitable institution provides the server host with a menu for a particular period which is entered and maintained in the database within the memory 14. The meal plan administrator accesses the server 12 by requesting meal (e.g. lunch) selection data 56 for a given time period (e.g. day, week, semester or other applicable time period). The selection data request 56 may be provided by any applicable network connection mechanism, for example, a browser or dedicated connection. The server 12 transmits aggregate or selected meal selection data 58 from the database to the authorized meal plan administrator for subsequent use by the meal plan administrator. Such uses may include ordering the required number of lunches from one or more vendors, for example, restaurants, delis or other suitable food providing entity that service the meal program.

FIGS. 2-4 represent a flowchart illustrating the operating steps performed by the server 12 when performing the online meal program. In step 202, the server receives access request parameters from a school lunch participant, for example a student or the parent of the student. This corresponds to the participant, for example, at client 20 connecting to the communication network 40 and accessing the server 12 as described above. Once connected, the participant is directed to a log in screen, as illustrated in FIG. 5. The log in screen 500 prompts the participant to enter the following identification or access parameters: Name 510, Address 512, E-mail address 514, which is used as a backup identification check and address to send electronic correspondence, telephone number 516, student (e.g. participants) name 518 and school code 520. The school code (e.g. BE) 520 identifies which school (e.g. Baywood Elementary) lunch program is to be accessed. Upon receiving the log in screen 500, the participant enters the requested access parameters, which are then transmitted to the server 12.

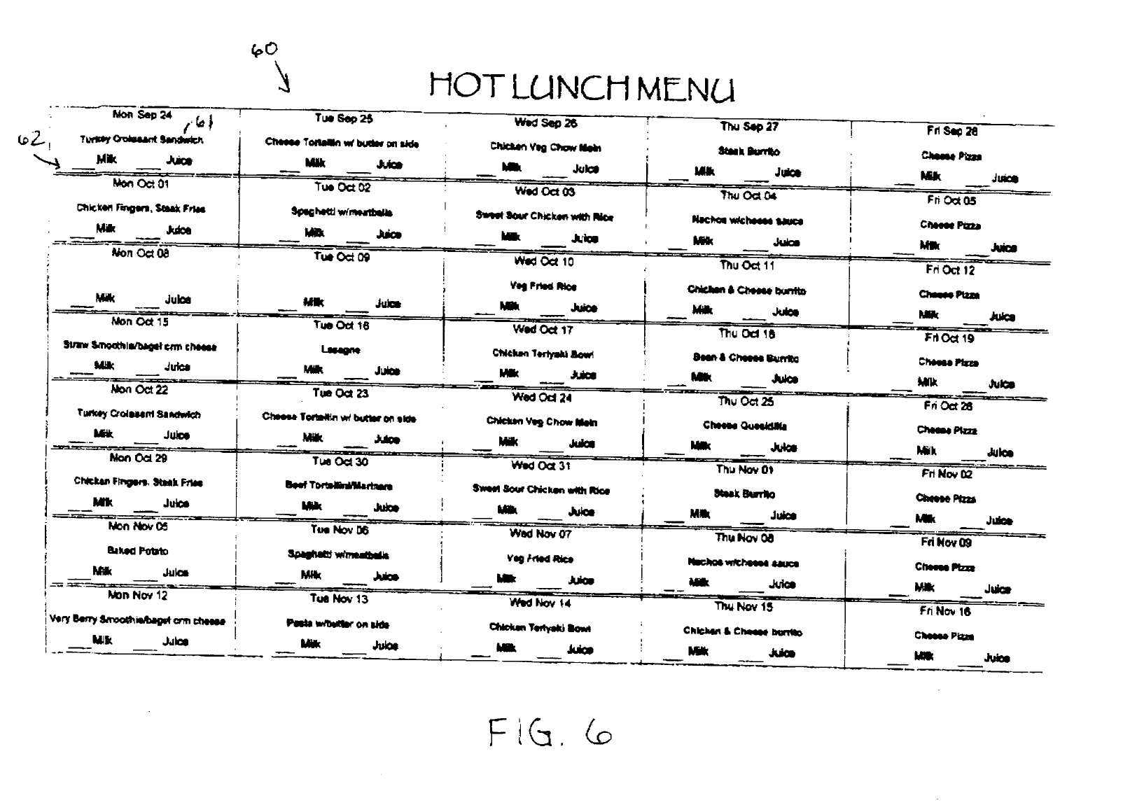

In step 204, after receiving the access request parameters, the server 12 provides the appropriate school menu page to the participant. This corresponds, for example, to transmitting the menu illustrated in FIG. 6. Referring briefly to FIG. 6, the menu 60 is divided into daily sections including at least one entrée 61 and at least one beverage selection 62 (e.g. milk or juice). Although a single entrée is listed in the menu 60, it will be appreciated and understood by one of ordinary skill in the art that multiple entrée selections may be provided per time period in either a drop down menu fashion or separately listed. In either situation, the participant (e.g. student or parent) may select from the available options.

In step 206, the server receives meal selection data from at least one participant. This is accomplished, for example, to the student selecting one or more entrees from either the drop down menu or the listed choices. A turkey croissant sandwich is one illustrated entree 61 for the particular period. Additional entrees, for example, Chicken Corn Dogs or Peanut Butter and Jelly sandwiches may also be provided as choices by the school or participating institution. Beverage choices for the particular period include milk or juice, for example, apple, grape, orange or any other suitable beverage.

After the entrée, beverage and side order choices, if applicable, are made the student or person making the meal selection is directed to a payment server 18 (FIG. 1) where provisions for paying for the lunch are made. In an exemplary embodiment, the student is linked to a payment page where credit card, debit card or other payment information 17 (FIG. 1) is provided and a payment and authorization request 38 (FIG. 1) is transmitted to the applicable financial institution. Upon receiving payment authorization 48 (FIG. 1), for example, sufficient funds verification and funds transfer to an account maintained by the server host or meal plan administrator, the student is provided with a confirmation page (not shown) listing the meal selection and cost of the meal. In an exemplary embodiment, the student is instructed to print the confirmation page. Alternatively, the confirmation page is sent to the student or person making the meal selection at the designated e-mail address 514 (FIG. 5).

In step 208, the server maintains the at least one meal selection data in an accessible format. This is accomplished, for example, by the database software causing the server 12 (FIG. 1) to perform the operations illustrated in FIG. 3. In step 2081, the received meal selection data is stored in the database maintained within the server. In an exemplary embodiment, meal selection is indexed by student as illustrated in FIG. 7. For example, Tanner Bost has selected to have a Chicken Corn Dog and Milk for lunch on Mar. 24, 2003. In similar fashion, Sophia Mandema has selected to have a Peanut Butter and Jelly sandwich and Milk for lunch on Mar. 24, 2003. Each of the aforementioned lunch selections is maintained in the database, and is indexed by the student's name. As will be appreciated by one of ordinary skill in the art, name indexing is but one of a myriad indexing methods used to maintain the integrity of database contents. Any other suitable indexing methods can be used in connection with the present invention and such other methods are contemplated by the present invention and fall within the spirit and scope of the present disclosure.

In step 2082, the database determines the total number of meal orders or selections, per institution. This is accomplished, for example, by calculating the total number of entrees selected. The calculation can be by individual entrée or, alternatively, can be an aggregate number of entrees selected. FIG. 8 illustrates the entrée based calculation method. In the exemplary embodiment, 84 Chicken Corn Dog entrees and 25 Peanut Butter and Jelly sandwich entrees were selected. 63 Juice and 42 Milk selections were also made. FIG. 9 illustrates the aggregate calculation method. As shown, for the period of Mar. 24, 2003 through Mar. 28, 2003, a total of 467 entrees were selected. By automatically determining the number of entrees to be ordered, the meal plan administrator does not have to spend valuable time manually counting the total number of meals that need to be ordered, and determining which meal corresponds to which student. This increased efficiency allows for the meal plan administrator to more effectively order the meals from suitable vendors as well as more efficiently run the meal program as fewer calculating and order mistakes are encountered using the system and method of the present invention. In alternate embodiments, the student or other authorized person (e.g. parent) may change the lunch order by a given cut off period. As long as the cut off period limitation is met, the student is provided with the changed lunch without causing any undue burden on the meal plan administrator.

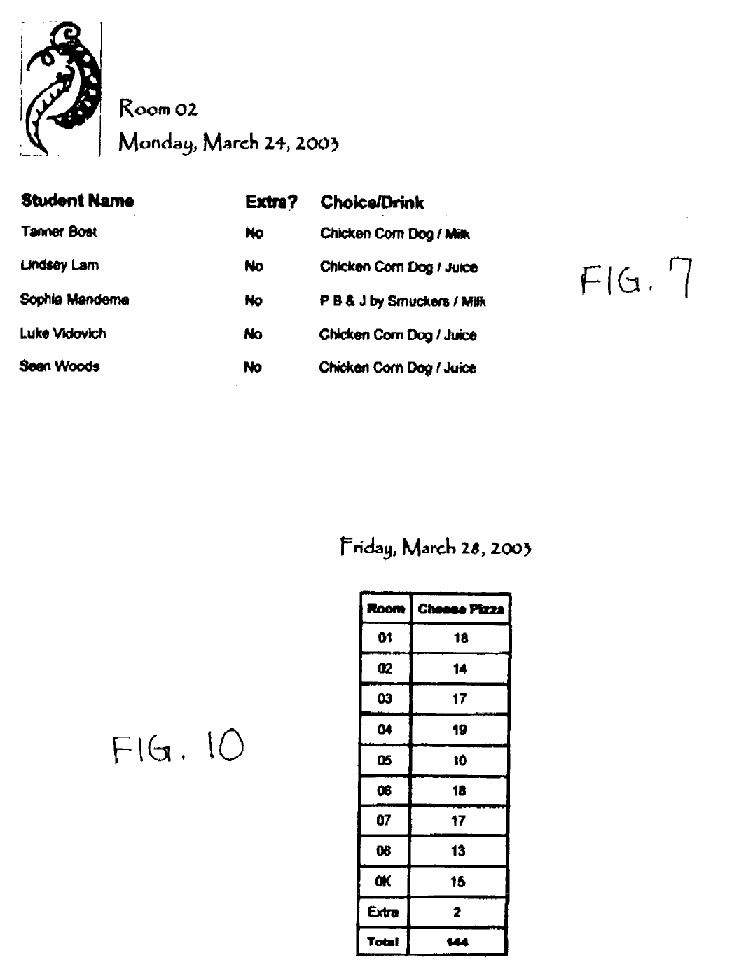

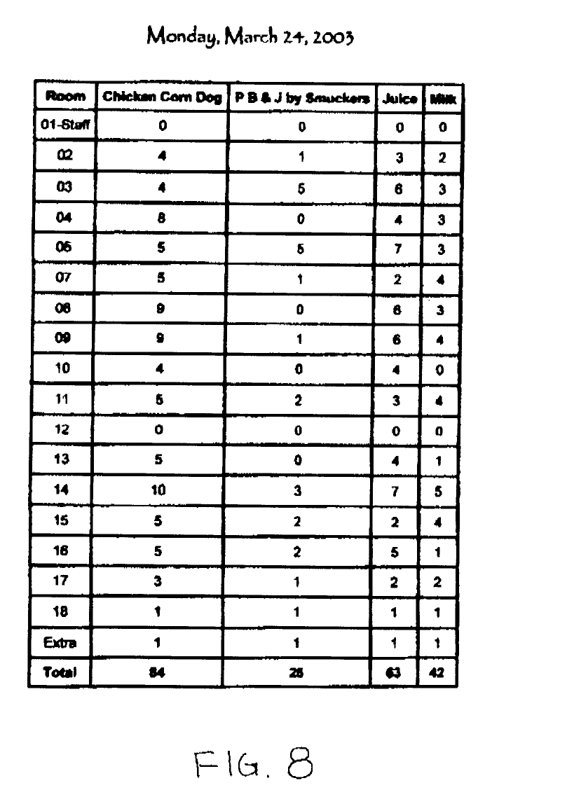

In step 2083, a table of the total number of meal orders per institution is generated. This is accomplished, for example, by the database software generating the tables illustrated in FIGS. 9-10. FIG. 9 is a table listing the total or aggregate number of entrees ordered for a particular time period. Alternatively, the entrée orders may be separated by a parameter, for example, classroom orders. FIG. 10 is a table listing, for example, the number of entrée (e.g. Cheese Pizza) orders per classroom and the aggregate number of entrees ordered.

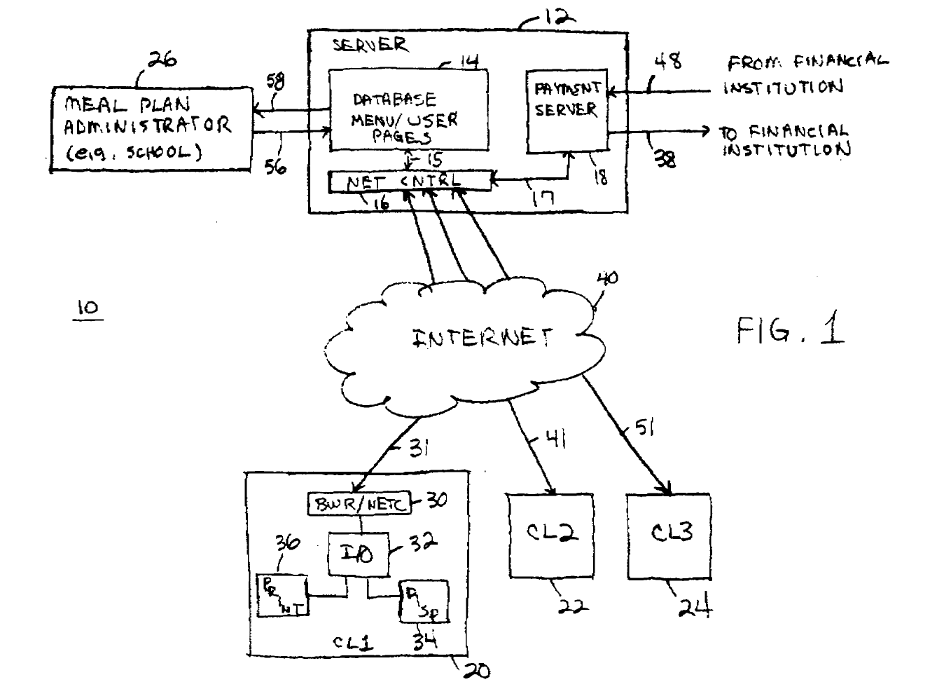

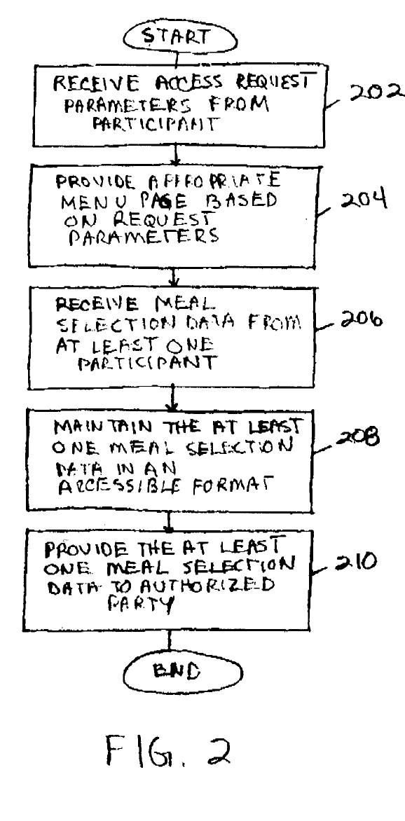

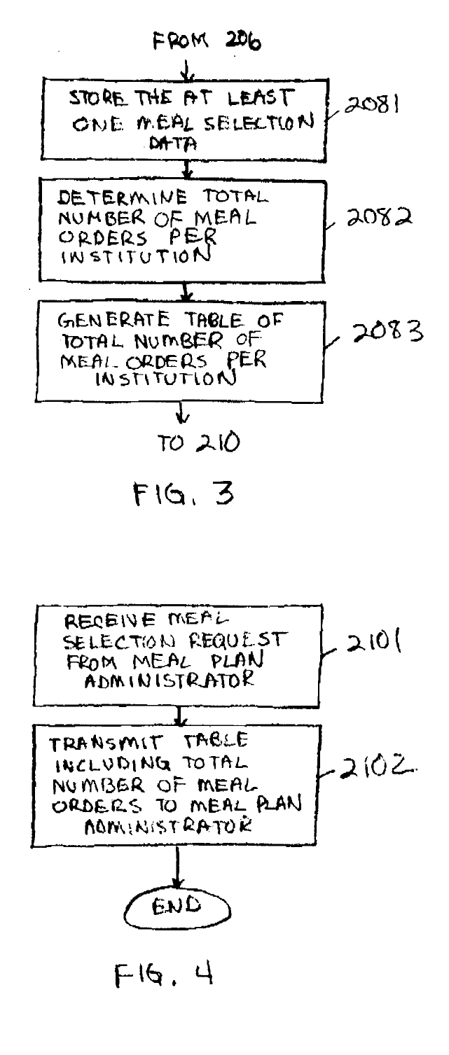

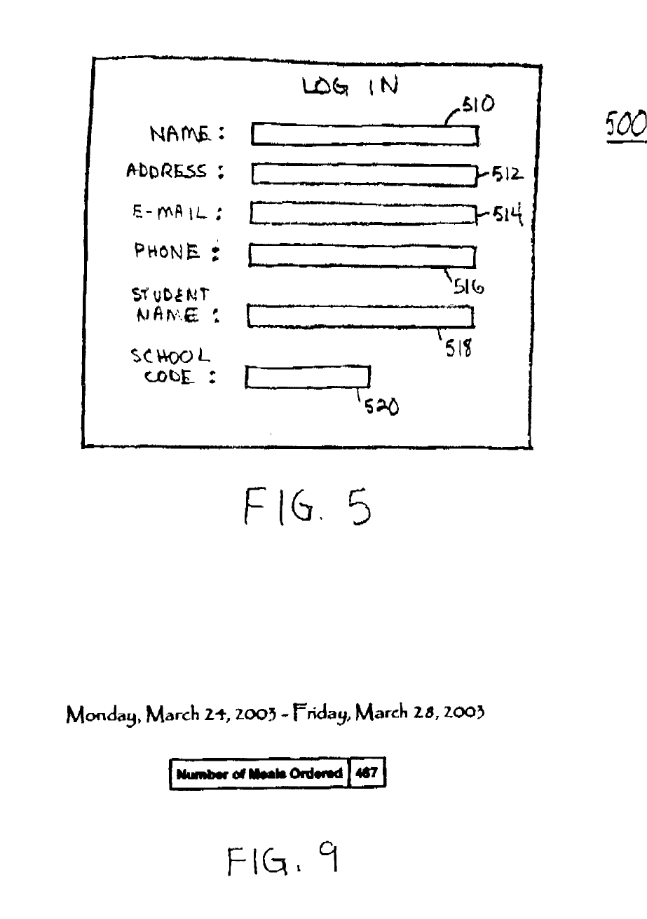

Referring back to FIG. 2, in step 210 the at least one meal selection data is provided to an authorized party. This is accomplished, for example, by the server 12 (FIG. 1) performing the operations illustrated in FIG. 4. In step 2101, a meal selection request from an authorized meal plan administrator is received. This corresponds to the meal plan administrator accessing the server database for their respective institution and requesting the lunch orders for a particular period 56 (FIG. 1). In step 2102, the database server transmits one or more of the tables illustrated in FIGS. 7-10 to the authorized meal plan administrator 58 (FIG. 1). The process then ends.

As discussed above, upon receiving the requested information from the server, the meal plan administrator can efficiently and effortlessly order the proper amount of entrees, beverages and side dishes, if applicable from the vendor(s) that service the meal program. Alternatively, the lunch ordering may be performed by a third party service, for example, the server provider with authorization from the meal plan administrator. By having a third party service order and/or deliver the selected lunches, the meal plan administrator is relieved of having to conduct the day-to-day maintenance of the lunch or other suitable meal program. This may result in cost and time savings to participating institutions as the hassles associated with ordering and maintaining relationships with food and beverage vendors is handled by the third party.

Revenue is generated by the exemplary system and method by the owner of the database server charging each school or other suitable institution a registration fee, for example $5.00 (one time registration fee) and periodic maintenance fees to participate in the online program. By maintaining their membership in the online meal program, the school or other suitable institution may access the database and receive the plurality of reports generated by the present invention. Additionally, the owner of the server receives a registration or log-on fee, for example $3.00 and a percentage, for example, three percent of the total lunch order cost from each client (e.g. student or parent). The percentage may be taken from individual lunch order or can be taken from the aggregate amount of lunch orders made over a prescribed time period. When the percentage is taken from individual lunch orders, the owner of the database server is paid the percentage amount during the payment authorization and funds transfer step discussed in greater detail above.

The above detailed description of the invention and the examples described therein have been provided for the purposes of illustration and description. Although an exemplary embodiment of the present invention has been described in detail herein with reference to the accompanying drawings, it is to be understood and appreciated that the present invention is not limited to the precise embodiment disclosed, and that various changes and modifications to the invention are possible in light of the above teaching. Accordingly, the scope of the present invention is to be defined by the claims appended hereto.

What is claimed is:

1. An online meal customization and reporting method, comprising:
(a) receiving meal selection data from at least one participant;
(b) maintaining the at least one meal selection data in an accessible format; and
(c) providing the at least one meal selection data to an authorized party.

2. The online meal customization and reporting method of claim 1, wherein the meal selection data includes one of the following: at least one entrée and one beverage.

3. The online meal customization and reporting method of claim 2, wherein the meal selection data further includes one side dish.

4. The online meal customization and reporting method of claim 1, wherein the meal selection data includes at least one side dish.

5. The online meal customization and reporting method of claim 1, wherein the maintaining step further comprises:
(b1) storing the at least one meal selection data in an accessible format;
(b2) determining the total number of meal orders per institution;
(b3) generating a table representing the total number of meal orders per institution.

6. The online meal customization and reporting method of claim 5, wherein the determining step further comprises determining the total number of entrée orders per institution.

7. The online meal customization and reporting method of claim 1, wherein the step of providing the at least one meal selection further comprises:
(c1) receiving a meal selection request from a meal plan administrator; and
(c2) transmitting a table containing the total number of meal orders to the meal plan administrator.

8. An online meal customization and reporting method, comprising:
(a) receiving access request parameters from a participant;
(b) providing a menu page based on the access request parameters;
(c) receiving meal selection data from at least one participant;
(d) maintaining the at least one meal selection data in an accessible format; and
(e) providing the at least one meal selection data to an authorized party.

9. The online meal customization and reporting method of claim 8, wherein the access request parameters further comprise: student name and institution code.

10. The online meal customization and reporting method of claim 9, wherein the access request parameters further comprise: participant name, participant address, participant e-mail address, and participant phone number.

11. The online meal customization and reporting method of claim 8, wherein the participant is one of the following: student or parent of student.

12. The online meal customization and reporting method of claim 8, wherein the meal selection data includes one of the following: at least one lunch entrée and one beverage.

13. The online meal customization and reporting method of claim 12, wherein the meal selection data further includes one side dish.

14. The online meal customization and reporting method of claim 8, wherein the maintaining step further comprises:
(d1) storing the at least one meal selection data in an accessible format;
(d2) determining the total number of meal orders per institution;
(d3) generating a table representing the total number of meal orders per institution.

15. The online meal customization and reporting method of claim 14, wherein the determining step further comprises determining the total number of lunch entrée orders per institution.

16. The online meal customization and reporting method of claim 1, wherein the step of providing the at least one meal selection further comprises:
(e1) receiving a meal selection request from a meal plan administrator; and
(e2) transmitting a table containing the total number of lunch orders to the plan administrator.

17. A customized lunch ordering and reporting system, comprising:
at least one processor; and
memory, coupled to the at least one processor, the memory including instructions that when executed on the at least one processor, causes the at least one processor to: receive a lunch selection from at least one participant; maintain the at least one lunch selection in an accessible format; and provide the at least one lunch selection to an authorized party.

18. The customized lunch ordering and reporting system of claim 17, wherein the instructions further cause the at least one processor to: determine the total number of lunch orders per institution; and generate a table representing the total number of lunch orders per institution.

19. The customized lunch ordering and reporting system of claim 17, wherein the instructions further cause the at least one processor to receive at least one lunch entrée selection and a beverage selection.

20. The customized lunch ordering and reporting system of claim 17, wherein the instructions further cause the at least one processor to generate table representing an association between the lunch entrée selections and the at least one participant.
